(19) United States
(12) Patent Application Publication
(10) Pub. No.: US 2001/0040641 A1
(43) Pub. Date: Nov. 15, 2001

(54) Multistandard clock recovery circuit

(76) Inventor: Ulrich Englert, Munchen (DE)

Correspondence Address: LERNER AND GREENBERG, P.A., POST OFFICE BOX 2480, HOLLYWOOD, FL, 33022-2480, US

(21) Appl. No.: 09/822,023

(22) Filed: Mar. 29, 2001

Related U.S. Application Data
(63) Continuation of application No. PCT/DE99/02886, filed on Sep. 13, 1999.

(30) Foreign Application Priority Data
Sep. 29, 1998 (DE) 198 44 700.0

(51) Int. Cl. H04N 7/00; H04N 11/00

(52) U.S. Cl. 348/468; 348/537

(57) ABSTRACT

The circuit recovers teletext signals, notably VPS, TXT, WSS and similar signals, from a video signal with concurrent production of the standard scanning frequency of the respective teletext signal. The recovery circuit has a single phase locked loop circuit which generates a reference frequency from a basic frequency supplied by an oscillator circuit. The reference frequency is a multiple of the scanning frequency in question. To scanning frequency is extracted from the reference frequency with a frequency divider.

### CROSS-REFERENCE TO RELATED APPLICATION

This application is a continuation of copending International Application No. PCT/DE99/02886, filed Sep. 13, 1999, which designated the United States.

### BACKGROUND OF THE INVENTION

Field of the Invention

The present invention relates to a multistandard clock recovery circuit for recovering individual teletext signals from a video signal with a plurality of teletext signals (TTD) of different standards (VPS, TXT), with generation of the respective standardized sampling frequency (f_{VPS}, f_{TXT}) of the respective standard (VPS, TXT), with a PLL circuit. The circuit of this general kind is described in published European patent application EP 0 390 958.

In order to recover teletext signals on a video signal, such as a CVBS signal for instance, the phase information of this signal must be extracted during the “clock run-in phase” in order to be able to sample the signal clock-synchronously in a downstream digital circuit. Since, in the vertical blanking interval of the signal, a plurality of teletext signals of different types or standards can be transmitted in successive television lines, such as, for instance, a VPS, TXT, WSS, CC signal and the like, a recovery circuit must be able to extract the different clock frequencies in a line-by-line manner.

A recovery circuit having a multiplicity of PLL circuits (primarily of the H-PLL type) has been used heretofore for this purpose, a first PLL circuit locked onto the line frequency generating a multiple of the line frequency which corresponds to the desired sampling frequency of the signal. This clock signal is then applied to a second PLL circuit via a phase shifter during the clock run-in phase, which second PLL circuit locks onto the clock run of the signal to be subdivided or sliced. Typical applications for this are VPS/PDC decoders, TVTs and the like.

For a multistandard solution, the recovery circuit in accordance with the prior art requires as many PLL circuits as there are standards that are to be supported. As a result, the prior art circuit concept is complex in respect of components and thus not cost-effective. Furthermore, the time constant of a PLL circuit is generally so high that it is not possible to integrate the requisite loop filters in an analog embodiment cost-effectively. This means that at least one additional pin or connection of the integrated module in which the recovery circuit is implemented is required for each standard. Finally, the clock signal of each PLL circuit, which represents a phase shifter, has to be pulled from one frequency to the next in a line-by-line manner. The associated transient recovery time constant is at odds with the requirements of obtaining the slowest possible transient recovery time constant for the phase-shifting operation. Therefore, a compromise with regard to the dimensioning has been essential heretofore and an inadequate sampling performance has thus been unavoidable. In the case of extreme frequency differences—for example 1 MHz for the CC or closed caption signal and 6.9375 MHz for the teletext signal—a respective PLL circuit has to be provided per standard, which again results in a relatively complex circuit and hence high costs.

### SUMMARY OF THE INVENTION

The object of the present invention is to provide a circuit for multistandard clock recovery which overcomes the above-noted deficiencies and disadvantages of the prior art devices and methods of this general kind, and which, in conjunction with a distinctly higher performance, can be realized with a relatively small number of components and nevertheless ensures a higher performance than the circuit according to the prior art.

With the above and other objects in view there is provided, in accordance with the invention, a multistandard clock recovery circuit for recovering individual teletext signals from a video signal with a plurality of teletext signals of mutually different standards each having a respective standardized sampling frequency, comprising:

a single PLL circuit configured to generate from a basic frequency provided by an oscillator circuit a standard-independent reference frequency, the reference frequency being a multiple of a respective sampling frequency of a given standard; and

a frequency divider connected to generate from the reference frequency the respective sampling frequency of the given standard.

In accordance with an added feature of the invention, the PLL circuit includes:

a frequency and phase detector having a first input receiving a signal with the basic frequency, a second input, and an output;

a phase detector having a first input receiving teletext signals, a second input, and an output;

a voltage-controlled oscillator having an input connected to the output of the frequency and phase detector and to the output of the phase detector and an output, outputting the reference frequency, and connected to an input of a respective the frequency divider and to the second input of the frequency and phase detector;

a multiplexer having an input connected to receive output signals of the respective the frequency dividers, and an output connected to the second input of the phase detector.

In accordance with an additional feature of the invention, a respective further frequency divider is connected upstream of the first and second inputs of the frequency and phase detector.

In accordance with another feature of the invention, a further multiplexer is connected between the outputs of the frequency and phase detector and of the phase detector and the input of the voltage-controlled oscillator.

In accordance with a further feature of the invention, each frequency divider is configured to generate a respective doubled sampling frequency from the reference frequency.

In accordance with again a further feature of the invention, the oscillator circuit is a crystal oscillator circuit.

In accordance with a concomitant feature of the invention, for generating a PAL/VPS signal and a PAL/TXT signal from the teletext signal, for example, the basic frequency is 6 MHz and the reference frequency is 138.75 MHz, and the frequency dividers include

a frequency divider for obtaining a VPS sampling frequency with a division factor 13.875; and

a frequency divider for obtaining a TXT sampling frequency with a division factor 10; and

wherein a first further frequency divider with a division factor 8 is connected upstream of the first input of the frequency and phase detector; and

a second further frequency divider with a division factor 185 is connected upstream of the second input of the frequency and phase detector.

In other words, the circuit according to the invention is based on a single PLL circuit and, in contrast to the prior art, the sampling frequency of the signal to be recovered is no longer generated in a line-locked manner, but rather on the basis of a single crystal frequency (basic frequency).

Provision is made for generating a standard-independent reference frequency from the crystal basic frequency, the respective sampling frequencies being obtained from the standard-independent frequency with the aid of dividers. The doubled sampling frequencies are preferably generated in order to ensure a balanced behavior during phase shifting with the phase detector of the PLL circuit.

The reference frequency which, according to the invention, is generated from the crystal-stable basic frequency and from which the sampling frequencies are obtained by means of frequency dividers essentially represents a frequency that can be chosen independently. In practice, however, frequencies to be considered are those which represent a common multiple of the sampling frequencies to be obtained. Frequency dividers can currently be implemented in 1/16 steps, for which reason the reference frequency chosen is 138.75 MHz, corresponding for example to 27.5 times the VPS frequency and 20 times the teletext frequency.

During operation of the circuit according to the invention, at the beginning of the clock run-in, the clock signal of the respective sampling frequency is shifted in phase with respect to the datum. After the next H pulse, a changeover is then made to the other of the two phase detectors.

The following advantages are obtained by the circuit according to the invention:

only a single PLL circuit is required irrespective of the number of standards;

on account of the stable frequency of the basic frequency, the I proportion can be chosen to be as large as desired without adversely affecting the stability of the sampling in the event of changeover between different standards;

the number of pins or connections of an integrated component in which the circuit according to the invention is implemented is reduced to one irrespective irrespective of the number of standards supported for all of the standards in comparison with the prior art; and

since, in contrast to the prior art, the clock signal is now no longer coupled to the line frequency, it is also possible to slice video recorder signals, something which has not been possible hitherto on account of sudden phase changes in the horizontal signal.

Other features which are considered as characteristic for the invention are set forth in the appended claims.

Although the invention is illustrated and described herein as embodied in a multistandard clock recovery circuit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram showing a first embodiment of the circuit according to the invention; and

FIG. 2 is a block circuit diagram of a second embodiment of the circuit according to the invention.

### DESCRIPTION OF THE PREFERRED EMBODIMENTS

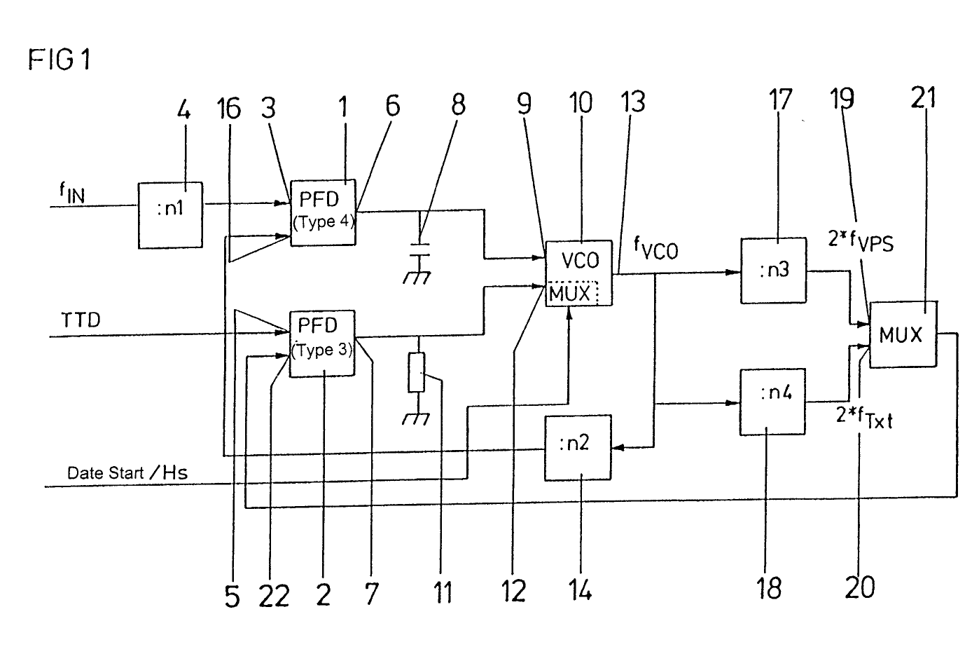

Referring now to the figures of the drawing in detail and first, particularly, to FIG. 1 thereof, the first exemplary embodiment of the circuit according to the invention is a clock recovery circuit and is based on a single PLL circuit having two switchable frequency and phase detectors, which will also be referred to as PFD hereinafter and which are designated by the reference numerals 1 and 2, respectively. The PFD 1 is a so-called type 4 PFD, which is both frequency- and phase-sensitive and alters the phase in the PLL circuit. The PFD 2 is a “type 3 PFD”, which is purely a phase-sensitive detector and alters exclusively the phase of the PLL circuit.

Both the PFD 1 and the PFD 2 have two inputs and in each case one output. A basic signal f_{IN} is applied to the first input 3 of the PFD 1 via a frequency divider 4, which will be discussed in detail below. The signal to be recovered—the TTD (teletext data) signal in the example illustrated—is directly present at a first input 5 of the second PFD 2. The output 6 of the first PFD 1 is connected via a capacitor 8 to ground and to a first input 9 of a voltage-controlled oscillator or VCO 10. An output 7 of the PFD 2 is connected via a resistor 11 to ground and to a second input 12 of the VCO 10. An output 13 of the VCO 10 is applied via a frequency divider 14 to the second input 16 of the PFD 1. In addition, the output 13 of the VCO 10 is connected to a frequency divider 17 and a frequency divider 18, which, on the output side, are connected to inputs 19 and 20 of a multiplexer 21, whose output is connected to the second input 22 of the PFD 2. Table 1 below lists, for the case of a PAL video signal, the values of the basic frequency f_{IN} and of the reference frequency f_{VCO} available at the output of the VCO 10, and likewise the division factors of the frequency dividers 4, 14, 17 and 18. For the case where the sampling frequencies for the PAL-VPS signal and the PAL/TXT signal are intended to be obtained with the aid of the dividers 17, 18.

TABLE 1

| f_{IN} | f_{VCO} | n1 | n2 | n3 | n4 | Delta f |
|---|---|---|---|---|---|---|
| 6 MHz | 138.75 MHz | 8 | 185 | 13.875 | 10 | 0% |

In this case, Delta f designates the deviation between the actual frequency (i.e. output of the PLL) and the desired setpoint frequency.

The circuit shown in FIG. 1 operates as follows.

At all times when there is no TTD signal present, the PLL circuit, in a manner determined by the divider ratios n1, n2, oscillates at a multiple of the basic frequency (in the present case at 138.75 MHz with f_{IN} equal to 6 MHz). This clock signal, in a manner determined by the frequency dividers 17, 18 with the division ratio n3 and n4, respectively, is divided down to the TXT frequency and VPS frequency, respectively, of two times 6.9375 and 5 MHz, respectively. In other words, the two required system frequencies for separating the data in this respect are available at any time without any transient process as in the case of the prior art.

Given identification of the data start or presence of a TTD signal, a changeover is made from the PFD 1, which is sensitive both to frequencies and to phases, to the merely phase-sensitive PFD 2, which, consequently, depending on the standard chosen, shifts either the VPS clock signal or the TXT clock signal in phase with respect to the incoming data.

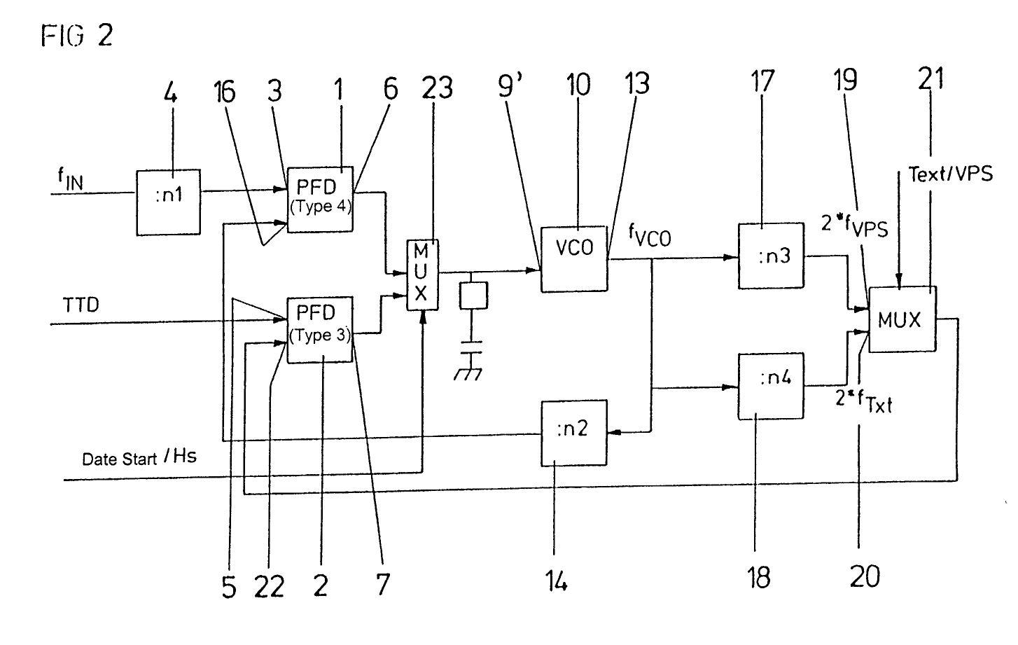

FIG. 2 shows an alternative embodiment to the circuit of FIG. 1, the same circuit parts being designated by the same reference numerals, which means that a separate explanation is unnecessary.

The circuit variant of FIG. 2 comprises, in addition to that of FIG. 1, a multiplexer 23 connected between the outputs 6, 7 of PFD 1 and PFD 2, respectively, and the input 9′ of the VCO 10. Data start/Hs is fed as a further input signal to the multiplexer 23. Moreover, the capacitor 8 and the resistor 11 in accordance with the embodiment of FIG. 1 are combined to form an RC element and connected downstream of the multiplexer 23.

The purpose of the multiplexer 23, which is integrated in the VCO 10 in the exemplary embodiment of FIG. 1, consists firstly in setting the output frequency of the VCO 10 to a stable value as a function of the output of the phase detector 3. Once the VCO 10 oscillates at this stable frequency, the multiplexer 23 changes over to the output of the phase detector 2 as a result of the control signal “Data start/HS”.

I claim:

1. A multistandard clock recovery circuit for recovering individual teletext signals from a video signal with a plurality of teletext signals of mutually different standards each having a respective standardized sampling frequency, comprising:
a single PLL circuit configured to generate from a basic frequency provided by an oscillator circuit a standard-independent reference frequency, the reference frequency being a multiple of a respective sampling frequency of a given standard; and
a frequency divider connected to generate from the reference frequency the respective sampling frequency of the given standard.

2. The circuit according to claim 1, wherein said PLL circuit includes:
a frequency and phase detector having a first input receiving a signal with the basic frequency, a second input, and an output;
a phase detector having a first input receiving teletext signals, a second input, and an output;
a voltage-controlled oscillator having an input connected to said output of said frequency and phase detector and to said output of said phase detector and an output, outputting the reference frequency, and connected to an input of a respective said frequency divider and to said second input of said frequency and phase detector;
a multiplexer having an input connected to receive output signals of the respective said frequency dividers, and an output connected to said second input of the phase detector.

3. The circuit according to claim 2, wherein a respective further frequency divider is connected upstream of said first and second inputs of said frequency and phase detector.

4. The circuit according to claim 2, wherein a further multiplexer is connected between said outputs of said frequency and phase detector and of said phase detector and said input of said voltage-controlled oscillator.

5. The circuit according to claim 1, wherein each said frequency divider is configured to generate a respective doubled sampling frequency from the reference frequency.

6. The circuit according to claim 1, wherein said oscillator circuit is a crystal oscillator circuit.

7. The circuit according to claim 2, wherein, for generating a PAL/VPS signal and a PAL/TXT signal from the teletext signal, the basic frequency is 6 MHz and the reference frequency is 138.75 MHz, and said frequency dividers include
a frequency divider for obtaining a VPS sampling frequency with a division factor 13.875; and
a frequency divider for obtaining a TXT sampling frequency with a division factor 10; and
wherein a first further frequency divider with a division factor 8 is connected upstream of said first input of said frequency and phase detector; and
a second further frequency divider with a division factor 185 is connected upstream of said second input of said frequency and phase detector.

8. A multistandard clock recovery circuit for recovering individual teletext signals from a video signal with a plurality of teletext signals of mutually different standards each having a respective standardized sampling frequency, comprising:
a single PLL circuit configured to generate from a basic frequency provided by an oscillator circuit a reference frequency independently of a given standard of a teletext signal to be processed, the reference frequency being a multiple of a respective sampling frequency of the given standard; and
a frequency divider connected to generate from the reference frequency the respective sampling frequency of the given standard.
